(19) United States
(12) Patent Application Publication
(10) Pub. No.: US 2026/0357138 A1
(43) Pub. Date: Nov. 12, 2026

(54) PLASTIC HYDROCRACKING APPARATUS FOR CONTINUOUS PROCESSING AND USE THEREOF

(71) Applicant: PLASTOGAZ SA, St-Sulpice (CH)

(72) Inventors: Felix Daniel BOBBINK, Nyon (CH); Antoine VAN MUYDEN, Lausanne (CH); Christopher Mare HUNSTON, Pully (CH)

(21) Appl. No.: 19/491,991

(22) PCT Filed: Jun. 11, 2024
(86) PCT No.: PCT/EP2024/066022

§ 371 Date: Dec. 10, 2025

(30) Foreign Application Priority Data
Jun. 12, 2023 (EP) 23178602.1
Jan. 22, 2024 (EP) 24153255.5

(51) Int. Cl. C10G 1/10; B01J 19/20

(52) U.S. Cl. CPC C10G 1/10; B01J 19/20; B01J 2219/00162; B01J 2219/00229; C10G 2300/1003; C10G 2300/4012

(57) ABSTRACT

The present invention relates to the field of hydrocracking of plastics and in particular provides an apparatus that can be used for the continuous production of hydrocarbon products, such as liquid and gaseous hydrocarbons, or feedstock for steam crackers, for example alkanes, from plastic and in particular mixed plastic, for example waste plastic. The apparatus of the present invention is characterized by improved safety in view of performing the hydrocracking process in a continuous manner.

### TECHNICAL FIELD

The present invention relates to the field of hydrocracking of plastics and in particular provides an apparatus that can be used for the continuous production of hydrocarbon products, such as liquid and gaseous hydrocarbons, or feedstock for steam crackers, for example alkanes, from plastic and in particular mixed plastic, for example waste plastic. The apparatus of the present invention is characterized by improved safety in view of performing the hydrocracking process in a continuous manner.

### BACKGROUND ART

Plastics have become useful and versatile materials with a wide range of applications. More and more new polymeric materials are developed to meet increasing demands. Plastics and other polymers are in theory recyclable. However, in practice after a relatively short functional life, large amounts of plastics are simply discarded as waste. Most of these plastics and other polymers disposed of in landfills are chemically stable and degrade minimally. This generates an increasing problem of plastic accumulation in the environment, while the demand for plastics keeps on increasing in most consumer products. To solve this problem, various processes have been developed to recycle plastics or chemically transform waste plastics into valuable compounds. There is therefore a need to further develop such technologies for the valorization of plastics and in particular waste plastics.

The hydrocracking of plastics to form various hydrocarbon materials has been disclosed in the prior art. The hydrocracking of plastic is mainly performed in a batch setup. However, to enable scaling up plastics hydrocracking, it would be advantageous to develop continuous hydrocracking processes and productions lines suitable to perform such continuous processes. As hydrocracking involves pressurized hydrogen, continuous hydrocracking processes are associated with more safety issues than batch processes. Therefore, ensuring the safety of a continuous process for the hydrocracking of plastics is a key challenge.

WO2012/076890A1 discloses a continuous process for the recycling of plastic materials, in particular waste plastic materials, into chemical feedstocks and hydrocarbon fractions by hydrocracking. The process comprises continuously introducing a waste plastic material as feedstock and hydrogen in a hydrocracking reaction chamber. Even though this document discloses the concept of a continuous process for hydrocracking plastics, it does not address the safety issues associated with a continuous process involving potential reverse flow with pressurized hydrogen.

US2018/282648A1 relates to a semi-continuous process for depolymerization of polyethylene waste in a pressurized reactor. The only part of the process that is continuous is the addition of the starting material in the reactor. The reaction is then performed batch-wise. It would be desirable to provide a fully continuous process.

Further prior art relates to depolymerisation of plastic material but are not relevant to hydrocracking of plastic. Depolymerisation only consists in deconstructing the polymer into smaller parts, up to its initial constituents. Hydrocracking also cleaves polymers but this is achieved under the effect of pressurized hydrogen and a catalyst. Thus, it requires special equipment and safety measures.

For example, US2018/346683A1 discloses a continuous process for depolymerization of plastic. This document does not disclose hydrocracking and does not even mention the use of hydrogen. Instead, it relates to a thermal process (i.e. pyrolysis) that can be performed in the presence or in absence of a catalyst. The reactor described does not comprise a gas injection port.

Similarly, DE102021105810A1 discloses a process for depolymerisation of plastic using a thermal process and is silent with respect to the use of hydrogen. The catalyst disclosed in this document is a zeolite catalyst without a metal, which is not compatible with a hydrocracking process, because the metal site of the zeolite catalyst is required for the hydrogenation reaction involved in a hydrocracking reaction such as described herein.

The present invention aims at solving the problem of the safety of a continuous process for the hydrocracking of plastics, such as waste plastics.

### SUMMARY OF THE INVENTION

In a first aspect the present invention provides a plastic hydrocracking apparatus for continuous processing comprising:
a) a melting element (1) adapted to melt plastic feedstock, wherein at least part of the plastic feedstock is in solid form, said melting element (1) comprising at least one inlet adapted to introduce the plastic feedstock into the melting element (1), at least one outlet adapted to extract the molten plastic feedstock from the melting element (1) and at least one means for conveying the plastic feedstock from an inlet of the melting element (1) to an outlet of the melting element (1);
b) a hydrocracking reactor (3) comprising an inlet adapted to continuously introduce molten plastic feedstock into a reactor chamber and at least one outlet adapted to extract hydrocracking products from the reactor (3); and
c) a transfer element (2) in fluid connection with the outlet of the melting element (1) and in fluid connection with the inlet of reactor (3);
   said plastic hydrocracking apparatus being characterized in that
I. the pressure at the outlet of the melting element (1) is higher than the pressure at the inlet of the melting element (1);
II. the pressure in the reaction chamber of reactor (3) is lower than the pressure at the outlet of the melting element (1);
III. the transfer element (2) comprises at least one first switching valve (22) adapted to either convey the molten plastic feedstock to the inlet of reactor (3) or to a tank (8); and
IV. the reactor (3) is provided with a pressure sensor adapted for sensing the pressure inside the reaction chamber of reactor (3) and for automatically controlling
   1. the at least one first switching valve (22), such as to convey the flow of molten plastic feedstock towards the tank (8) when the pressure in the reaction chamber of reactor (3) exceeds a predetermined level; and/or
   2. the at least one means for conveying the plastic feedstock from an inlet of the melting element (1) to an outlet of the melting element (1), such as to stop or reduce the speed of the conveying of plastic feedstock from the inlet of the melting element (1) to the outlet of the melting element (1); or
      the at least one means for conveying the plastic feedstock from an inlet of the melting element (1) to an outlet of the melting element (1), to increase the speed of the conveying of the molten plastic feedstock to the outlet of the melting element (1) when the pressure in the reaction chamber of the reactor (3) drops below a predetermined level.

In second aspect, the present invention relates to the use of a plastic hydrocracking apparatus of the invention for the production of hydrocarbon products by hydrocracking from plastic feedstock.

In a third aspect, the present invention provides a continuous process for the hydrocracking of plastic feedstock, wherein at least part of the plastic feedstock is in the solid state, said process comprising:
a) continuously introducing the plastic feedstock through at least one inlet of a melting element (1) adapted to melt the plastic feedstock
b) melting the plastic feedstock in the melting element (1);
c) continuously extracting the molten plastic feedstock from the melting element (1) through at least one outlet of the melting element (1);
d) continuously conveying the molten plastic feedstock into the hydrocracking chamber of a reactor (3) through a transfer element (2) and an inlet of the reactor (3);
e) performing a plastic hydrocracking process in the reactor chamber of reactor (3); and
f) extracting the obtained hydrocracking product(s) from the reaction chamber of reactor (3) through at least one outlet of the reactor (3),
   such process being characterized in that
I. a transfer element (2) is provided in fluid connection with the outlet of the melting element (1) and in fluid connection with the inlet of reactor (3) and comprises at least one first switching valve (22) adapted to either convey the molten plastic feedstock to the inlet of reactor (3) or to a tank (8);
II. the pressure at the outlet of the melting element (1) is higher than the pressure at the inlet of the melting element (1);
III. the pressure in the reaction chamber of reactor (3) is lower than the pressure at the outlet of the melting element (1); and
IV. the reactor (3) is provided with a pressure sensor adapted for sensing the pressure inside the reaction chamber of reactor (3) and for automatically controlling
   1. the at least one first switching valve (22) such as to convey the flow of molten plastic feedstock towards the tank (8) when the pressure in the reaction chamber of reactor (3) exceeds a predetermined level; and/or
   2. the at least one means for conveying the plastic feedstock from an inlet of the melting element (1) to an outlet of the melting element (1), to stop or to reduce the speed of the conveying of the molten plastic feedstock to the outlet of the melting element (1) when the pressure in the reaction chamber of the reactor (3) exceeds a predetermined level; or
      the at least one means for conveying the plastic feedstock from an inlet of the melting element (1) to an outlet of the melting element (1), to increase the speed of the conveying of the molten plastic feedstock to the outlet of the melting element (1) when the pressure in the reaction chamber of the reactor (3) drops below a predetermined level.

### BRIEF DESCRIPTION OF DRAWINGS

FIG. 1 Schematic representation of an example of a plastic hydrocracking apparatus according to the invention.

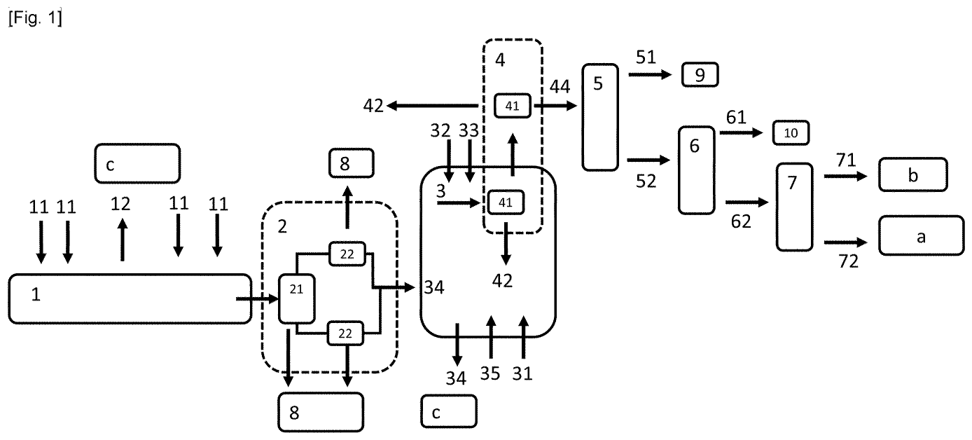

FIG. 2 Graph showing the evolution of the feed rate and the pressure difference over time during the safety assessment of Example 1.

### DETAILED DESCRIPTION

Unless defined otherwise, all technical and scientific terms used herein have the same meaning as is commonly understood by one of skill in art to which the subject matter herein belongs. As used herein, the following definitions are supplied in order to facilitate the understanding of the present invention.

The term “comprise” is generally used in the sense of include, that is to say permitting the presence of one or more features or components. In addition, as used in the specification and claims, the language “comprising” can include analogous embodiments described in terms of “consisting of” and/or “consisting essentially of”.

As used in the specification and claims, the term “and/or” used in a phrase such as “A and/or B” herein is intended to include “A and B”, “A or B”, “A”, and “B”.

As used in the specification and claims, the singular forms “a”, “an” and “the” include plural references unless the context clearly dictates otherwise.

As used herein the term “hydrocracking” refers to reacting a hydrocarbon substance with hydrogen over a bifunctional catalyst having both an acidic site (performing a cracking reaction) and a redox site (able to perform a hydrogenation/dehydrogenation and/or a hydrogenolysis reaction). Considering that different quantities of these active sites on the catalyst can be present and that activity of such sites differs depending on the applied conditions, the reaction involved is either catalytic cracking, hydrogenolysis or hydrogenation. Therefore, the present invention encompasses an apparatus and a process for continuous hydrocracking, hydrogenolysis and/or hydrogenation of plastic.

The invention relates to a continuous plastic hydrocracking apparatus having improved safety. Continuous processes are by nature associated with higher risks than batch processes. In particular risks are high when a continuous process becomes de-regulated and/or when the inlet flow of feedstock becomes higher than what the overall reaction line can withstand.

The risk is even higher in processes involving high pressures of flammable and explosive compounds, as it is the case with hydrocracking processes. In such cases, reverse flow of flammable/explosive reactive media coming from the reactor generates high risk. The present invention advantageously provides an apparatus provided with means for cross-control of the different parts of the apparatus, enabling key parts of the production line to regulate the flux of the feedstock, thus making it possible to regulate precisely the pressures at every key point of the production line (apparatus).

Any type of plastic can be continuously processed in the plastic hydrocracking apparatus of the present invention, including single plastic sources or mixed plastic sources, such as mixed waste plastics. Examples of suitable plastics polymers that can be used as starting material in the continuous hydrocracking process include polyolefins, ethylene vinyl alcohol (EVOH), poly lactic acid (PLA), polyethylene terephthalate (PET), polybutylene terephthalate (PBT), polytrimethylene terephthalate (PTT), polyethylene isosorbide terephthalate (PEIT), polyethylene furanoate (PEF), polyamide (PA), polyamide-6 or Poly(e-caprolactam) or polycaproamide (PA6), polyamide-6,6 or Poly(hexamethylene adipamide) (PA6,6), Poly(II-aminoundecanoamide) (PA11), polydodecanolactam (PA 12), poly(tetramethylene adipamide) (PA4,6), poly(pentamethylene sebacamide) (PA5,10), polyhexamethylene nonanediamideaamide (PA6,9), poly(hexamethylene sebacamide) (PA6,10), poly(hexamethylene dodecanoamide) (PA6,12), poly(m-xylylene adipamide) (PAMXD6), polyhexamethylene adipamide/polyhexamethyleneterephtalamide copolymer (PA66/6T), polyhexamethylene adipamide/polyhexamethyleneisophtalamide copolymer (PA66/61) polyurethane (PU), polyvinyl chloride (PVC), polyvinyl dichloride (PVDC), polyethylene (PE), polystyrene (PS), acrylonitrile butadiene styrene (ABS), poly(oxide phenylene) (PPO), polycarbonate (PC), copolymer of phosphono and carboxylic acid (PCA), high molecular weight polyacrylate, polymethacrylate methyle (PMMA), polyoxymethylene (POM), styrene acrylonitrile (SAN), polyester polymer alloy (PEPA), polyethylene naphthalate (PEN), styrene-butadiene (SB) and blends/mixtures of these materials.

In a particular embodiment, the polyolefin is selected from the group consisting of polyethylene, polypropylene, polymethylpentene, polybutene-1, polyisobutylene, ethylene propylene rubber, ethylene propylene diene monomer rubber, polystyrene polyvinylchloride and polyvinylidene chloride.

In a particular embodiment, the polyethylene is divided into low-density, linear low density, high-density and ultra-high-density polyethylene (LDPE, LLDPE, HDPE and UHDPE, respectively).

In another particular embodiment, the polypropylene is in the form of a homopolymer, a random copolymer or a block copolymer. It can also be described as atactic, syndiotactic or isotactic.

In another particular embodiment, the one or more plastic polymers is a polyester polymer, preferably selected from the group consisting of poly lactic acid (PLA), polyethylene terephthalate (PET), polybutylene terephthalate (PBT), polytrimethylene terephthalate (PTT), polyethylene isosorbide terephthalate (PEIT), polyethylene furanoate (PEF).

In a particular embodiment, the one or more plastic polymers is a polyamide polymer, preferably selected from the group consisting of polyamide-6 or poly(e-caprolactam) or polycaproamide (PA6), polyamide-6,6 or poly(hexamethylene adipamide) (PA6,6), poly(II-aminoundecanoamide) (PA11).

In a particular embodiment, the one or more plastic polymers further comprises at least one polymer selected from the group consisting of aliphatic polyester, polyvinyl alcohol, cellulose, polylactic acid (PLA), polyhydroxyalkanoate (PHA), starch-based polymers, poly(butylene adipate-co-terephthalate) (PBAT), polybutylene succinate (PBS), polybutylene succinate adipate (PBSA), and polycaprolactone (PCL).

The plastic can be pretreated or not. In case pretreatment is performed, the one or more plastic source can undergo a pretreatment, such as sorting, washing, cutting, crushing, chemical pretreatment, and the like.

### Apparatus

The apparatus of the invention comprises a melting element (1) adapted to melt plastic feedstock that is at least in part in solid form, said melting element (1) comprising at least one inlet adapted for introducing the plastic feedstock into the melting element (1), at least one outlet adapted to extract the molten plastic feedstock from the melting element (1) and at least one means for continuously conveying the plastic feedstock from an inlet of the melting element (1) to an outlet of the melting element (1).

In a preferred aspect, the melting element (1) further comprises at least one mixing means.

In a preferred aspect, the melting element (1) is adapted to supply heat to the plastic feedstock by mechanical shear and/or by means of an external heat source. Preferably, the heat is supplied at least in part by mechanical shear.

In a particular embodiment, the melting element (1) comprises at least one screw for providing heat by mechanical shear and for pushing the plastic feedstock along the screw axis, from the inlet of the melting element (1) to the outlet of the melting element (1). For example, the screw can be in the form of a single screw extruder or of a twin-screw extruder. The plastic feedstock is at least in part in the solid state when it enters the melting element (1) through the melting element (1) inlet and is heated by friction created between the screw and the plastic feedstock. In a specific aspect, additional heat is also provided by means of one or more external heat source(s).

In another particular embodiment, the melting element is also provided with one or more cooling means. Such cooling means is advantageous to avoid overheating of the melting element, in particular when heat is generated by mechanical shear, which can in some instances be difficult to precisely control.

In a preferred aspect, the melting element is provided with a temperature sensor adapted to control an external heating means and/or an external cooling means, such as to provide heat or cool the melting element and maintain the temperature inside the melting element (1) within a predetermined range.

The plastic feedstock is preferably heated enough to be at least partially molten when it leaves the melting element (1) through the melting element (1) outlet. Since the plastic feedstock is composed of different materials, part of the plastic feedstock can remain in the solid state within the molten plastic feedstock, thus forming a viscous paste (slurry).

In a preferred aspect, the melting element (1) comprises a temperature sensor adapted to activate at least one external heating means when the temperature at the outlet of the melting element (1) drops below a predetermined level. In another preferred aspect, the melting element (1) comprises a temperature sensor adapted to activate at least one external cooling means when the temperature at the outlet of the melting element (1) exceeds a predetermined level.

In a preferred aspect, the melting element (1) possesses one or more addition port(s) (11) adapted to add substances to the melting element (1) and/or one or more extraction port(s) (12) adapted to extract substances from the melting element (1). The substances that can be added to or extracted from the melting element (1) are solids, such as catalysts, liquids, such as water, and gases, such as hydrogen, air or steam, or slurries. Preferred materials that can be added to the melting element (1) through one or more addition port(s) (11) include hydrogen, water, steam, a catalyst or materials originating from the reactor element (3), such as unreacted or partially reacted materials. Addition of substances to the melting element (1) advantageously enables reaction of the added substance(s) with the plastic feedstock in the melting element (1) before it reaches the reactor element (3). Addition of a catalyst is further advantageous to increase such reaction rate. The presence of mixing means in the melting element (1) further improves the efficiency of the reactions that may take place in the melting element (1). Advantageously, materials can be extracted from the melting element (1) through one or more extraction ports (12), such as to apply vacuum in the melting element (1). For example, water, oxygen and/or other volatile components can be released from the plastic feedstock during melting in the melting element (1). Removal of such released substances from the melting element (1) through one or more extraction port(s) (12) makes it possible to control the amount of such substances present in the melting element (1) and/or to apply vacuum.

In a particular aspect, one or more extraction port of the melting element (1) is in fluid connection with one or more condensing vessel(s) (13) and/or one or more buffer tank(s) to collect solids and/or liquids that are extracted from the melting element (1).

In a preferred aspect, the pressure at the outlet of the melting element (1) is higher than the pressure at the inlet of the melting element (1). This is for example achieved when the melting element (1) comprises a screw that compresses the plastic feedstock towards the end of the screw element, at the outlet of the melting element (1).

In a preferred aspect, the melting element (1) comprises one or more pressure sensor(s) adapted to increase the flow of the plastic feedstock from the inlet of the melting element (1) to the outlet of the melting element (1) when the pressure at the outlet of the melting element (1) drops below a predetermined level and/or one or more pressure sensor(s) adapted to decrease the flow of the plastic feedstock from the inlet of the melting element (1) to the outlet of the melting element (1) when the pressure at the outlet of the melting element (1) exceeds a predetermined level.

The apparatus of the invention further comprises a transfer element (2) comprising an inlet in fluid connection with the outlet of the melting element (1) and an outlet in fluid connection with a hydrocracking reactor (3).

The transfer element (2) comprises at least one first switching valve (22) adapted to either convey the molten plastic feedstock to the inlet of reactor (3) or to a tank (8). Preferably, the transfer element (2) comprises two or more first switching valves (22) in parallel and further comprises at least one second switching valve (21), which is in fluid connection with the outlet of the melting element (1) and is adapted to convey the molten plastic feedstock towards either of the first switching valves (22) or to the tank (8). In an aspect, the second switching valve (21), is in fluid connection with the outlet of the melting element (1) and is adapted to convey the molten plastic feedstock towards either of the first switching valves (22). The second switching valve (21) aims at dividing the flux of molten feedstock into separate lines, that can be independently controlled by the means of the first switching valves (22). Thus, the flow of molten plastic feedstock can be fully directed to the reactor (3) or wholly or partially diverted to a tank (8) when required to ensure safety of the process, as each of the first switching valves (22) can be switched towards the reactor or towards the tank (8). This makes it possible to either completely stop the conveying of the molten plastic feedstock to the container in case of need or to only redirect part of the flow to the container (8) by switching part or all of the first switching valves (22). Preferably, second switching valve 21 is also adapted to direct the flux to the tank (8).

Redirection of the feedstock to the tank (8) advantageously makes it possible to adjust the pressure at the outlet of the melting element (1). When the first switching valve (22) redirects the feedstock towards the tank (8), the feedstock is pushed through an orifice. When the diameter of the orifice is smaller than the diameter of the outlet of the melting element (1), redirection to the tank (8) has the effect of increasing the pressure. When the diameter of the orifice is larger than the diameter of the outlet of the melting element (1), redirection of the feedstock to the tank (8) results in a reduction of the pressure at the outlet of the melting element (1).

Thus, in a specific aspect, when the first switching valve (22) redirects the feedstock towards the tank (8), the feedstock is pushed through an orifice, wherein the diameter of the orifice is smaller than the diameter of the outlet of the melting element (1), to increase the pressure at the outlet of the melting element (1). In another specific aspect, when the first switching valve (22) redirects the feedstock towards the tank (8), the feedstock is pushed through an orifice wherein the diameter of the orifice is larger than the diameter of the outlet of the melting element (1), to reduce the pressure at the outlet of the melting element (1). In a preferred aspect, when the first switching valve (22) redirects the feedstock towards the tank (8), the feedstock is pushed through an orifice having a variable diameter, wherein the diameter of the orifice is increased to a diameter larger than the diameter of the outlet of the melting element (1) to reduce the pressure at the outlet of the melting element (1) and/or wherein the diameter of the orifice is reduced to a diameter smaller than the diameter of the outlet of the melting element (1), to increase the pressure at the outlet of the melting element (1).

More preferably, the first switching valve (22) and, optionally the second switching valve (21) is/are adapted to be controlled by a pressure sensor provided at the outlet of the melting element (1), to increase the pressure at the outlet of the melting element (1) when it drops below a predetermined level or to reduce the pressure at the outlet of the melting element (1) when it exceeds a predetermined level.

In a preferred aspect, the transfer element (2) is provided with one or more heating means and/or with one or more cooling means, adapted to control the temperature inside the transfer element. This advantageously makes it possible to maintain the plastic feedstock in molten state. Preferably the temperature inside the transfer element (2) is maintained close to the temperature at the outlet of the melting element (1).

The apparatus of the invention further comprises at least one reactor element (3) comprising a reaction chamber wherein the hydrocracking reaction is to take place, a reactor inlet adapted to convey the molten plastic feedstock from the transfer element (2) to the reaction chamber and a product outlet adapted to extract the desired hydrocracking reaction product(s) from the reactor.

The reactor (3) is preferably provided with at least one means for controlling the temperature inside the reactor, preferably at least one heating means and/or at least one cooling means. In a preferred aspect, the temperature and the pressure in the reactor are adequate to perform the hydrocracking of the plastic feedstock.

The reactor element (3) comprises a pressure sensor to control the pressure inside the reactor. The reactor (3) operates at a lower pressure than the pressure at the outlet of the melting element (1). This advantageously ensures that no reverse flow occurs towards the melting element (1). The pressure sensor of the reactor element (3) is advantageously adapted to control the means for conveying the plastic feedstock from the inlet of the melting element (1) to the outlet of the melting element (1) to stop or to reduce the speed of the conveying of the molten plastic feedstock to the outlet of the melting element (1) and/or the pressure sensor of the reactor element (3) is adapted to control the at least one first switching valve (22) to direct the flow of plastic feedstock to the tank (8), when the pressure inside the reaction chamber exceeds a predetermined level. Alternatively or additionally, the pressure sensor of the reactor element (3) is advantageously adapted to control the means for conveying the plastic feedstock from the inlet of the melting element (1) to the outlet of the melting element (1), to increase the speed of the conveying of the molten plastic feedstock to the outlet of the melting element (1) when the pressure in the reaction chamber of the reactor (3) drops below a predetermined level.

Any type of reactor suitable for the performance of hydrocracking reaction can be used, provided that it is provided with a pressure control means capable of cross-controlling the first switching valve (22) and/or the means for conveying the plastic feedstock from the inlet of the melting element (1) to the outlet of the melting element (1), as described above. Provided that such cross-control is implemented, the continuous hydrocracking process can be performed safely, irrespective of the reactor type. Hydrocracking of the plastic feedstock refers to the reaction between the said plastic feedstock, hydrogen, and optionally a catalyst. Types of reactors suitable for performing hydrocracking processes are well-known to the person skilled in the art. Preferably, a catalyst is used.

The reactor element (3) preferably comprises at least one mixing means adapted to admix the plastic feedstock with hydrogen and optionally a catalyst, thus making the hydrocracking reaction more efficient. Any type of mixing means can be used, such as stirring equipment, static mixer, catalyst bed or passive mixing means.

The reactor element (3) preferably comprises at least one hydrogen injection means (31). Such hydrogen injection means (31) is preferably adapted to supply pressurized hydrogen to the reaction chamber. The hydrogen injection means (31) can be located at the bottom of the reactor or at the top or within the mixing element.

The reactor element (3) can optionally contain one or more additional gas injection element(s) (35), one or more liquid injection element(s) (32) and/or one or more solid addition port(s) (33), adapted to supply additional materials to the reactor, for example a catalyst addition port.

The reactor element (3) can optionally contain a liquid drain valve (34) to remove part of the reaction mixture. The liquid drain valve can be located at the bottom of the reactor or in the middle of the reactor or may be in the form of a pipe dipped at a certain level within the reactor mixture. The liquid drain valve can optionally be connected to a filter element (13) that separate solid materials from liquid materials. The filter element can be connected to a waste collection tank or to an inlet port (11) of the melting element (1).

In another aspect, the reactor element (3) comprises a solids removal port, for example suitable for removing catalyst and/or accumulated inorganic materials. Any suitable means for removing solids, which are well-known to the person skilled in the art can be used. In still another aspect, the reactor element (3) comprises a slurry removal port, for example suitable to extract catalyst dispersed in liquid and/or part of the reaction mixture.

In a particular embodiment, the reactor element (3) comprises a liquid level sensor, adapted to monitor the level of the reaction mixture in the reaction chamber of the reactor element (3). The liquid level sensor is adapted to control the means for conveying the plastic feedstock from the inlet of the melting element (1) to the outlet of the melting element (1) and the first switching valve (22) to maintain constant the liquid level inside the reactor. Thus, the liquid level sensor of the reactor element (3) is advantageously adapted to control the means for conveying the plastic feedstock from the inlet of the melting element (1) to the outlet of the melting element (1) to reduce or stop the conveying of molten plastic feedstock from the melting element (1) to the reactor (3) and/or to control the second switching valve (21) to redirect the flow of plastic feedstock to the tank (8) when the level of the reaction mixture inside the reaction chamber exceeds a predetermined level. Alternatively or additionally, the level sensor of the reactor element (3) is advantageously adapted to control the means for conveying the plastic feedstock from the inlet of the melting element (1) to the outlet of the melting element (1), to increase the speed of the conveying of the molten plastic feedstock to the outlet of the melting element (1) when the level of the reaction mixture in the reaction chamber of the reactor (3) drops below a predetermined level.

The presence of a level sensor advantageously avoids overfilling or underfilling of the reactor and makes it possible to maintain a constant volume inside the reactor, therefore maintaining a somewhat constant production and melt-to-catalyst ratio. It can also trigger a shutdown if the reactor is filling too rapidly.

In addition to its role as safety measure, the level sensor is also advantageous to monitor the progress of the hydrocracking reaction. This cannot be achieved by the pressure sensor. The beneficial role of the level sensor is due to the fact that various indicators of the reaction progress can be detected by a level sensor and not by a pressure sensor. Firstly, the level sensor can detect volume increase due the amount of hydrogen being sparged within the melt (~40% difference). In addition, it can provide a direct measure of the rate at which the plastic inside the reactor is consumed. Furthermore, the monitoring of the reaction progress by the level sensor is not affected by the density of the mixture, which is unknown and evolves over time. Therefore, operation of a continuous hydrocracking line is improved when the level sensor is present in addition to the pressure sensor.

Hydrocracking of the plastic feedstock refers to the reaction between the said plastic feedstock, hydrogen, and a catalyst. The overall combination of the apparatus and catalyst makes it possible to control product composition ranging from C1 to C24 products, such as any hydrocarbon from methane to naphtha, including LPG and aromatics. Reaction conditions and catalyst composition can be adapted to obtain the desired products.

In a preferred aspect, the catalyst is a bifunctional catalyst, preferably composed of an acidic active site and of a redox active site. Such catalysts are well-known to the person skilled in the art. In a particular embodiment, the catalyst is a ruthenium-modified zeolite that efficiently transforms plastic polymers to methane and/or liquid fuels. More preferably, a bifunctional catalyst as disclosed in WO 2020/104385.

The apparatus of the present invention further comprises an outlet element (4), adapted to extract the hydrocracking product from the reactor element (3). The product outlet is preferably selected from a gas outlet, a liquid outlet or a slurry outlet. The apparatus can optionally contain several product outlets, in particular different outlets for extracting gas, liquid and slurry products respectively. The product outlet element (4) is in fluid connection to the reactor element.

The product outlet (4) can in turn be in fluid connection with means for separating and purifying the products. Hydrocarbon purification and separation means are well-known to the person skilled in the art. Any such purification or separation means can be included in the apparatus of the present invention. The types of purification and separation means to be used mainly depend on the products that are intended to be obtained at the end of the process.

The following preferred embodiments provide a preferred set-up for the purification of light hydrocarbon products, preferably of hydrocarbon products having 1 to 16 carbon atoms.

In a particular embodiment, the product outlet element (4) is a gas outlet (4), adapted to withstand pressure and provided with at least one means for controlling the temperature in the outlet element (4) by means of heating and/or cooling element(s). The gas outlet element preferably comprises one more solid and liquid separation means (41), adapted to separate solids and liquids from the extracted gas materials. Such solids and liquids separation means (41) preferably operates by the means of centrifugal forces. The gas outlet element (4) preferably comprises at least two outlets, a gas outlet (44) for volatile products and a liquid and solid outlet (42). The gas outlet (44) is preferably in fluid connection to a condenser element (5). The solid and liquid outlet (42) can be in fluid connection to one addition port (11) of the melting element (1), to a liquid injection element (32), to a solid addition port (33) and/or to a storage tank. In a preferred aspect, the solids and liquids outlet (42) is in fluid connection to one addition port (11) of the melting element (1) and/or to a liquid injection element (32) of the reactor element (3). This is advantageous when the intended products are gases, as the solids and liquids can be re-introduced into the system for further reaction.

In a preferred aspect, the condenser element (5) is adapted to withstand pressure. The condenser element is adapted to enable expansion of the volatile products originating from the outlet element (4). The expansion in turn causes condensation of the products on the walls of the condenser element (5). The condenser element (5) can optionally further be cooled down by means of a cooling element.

The condenser element (5) has a gas inlet in fluid connection to the gas outlet element (4). Such gas inlet enables expansion of the gas and separation of gas and liquid products. Preferably, the condenser element (5) comprises an inner structure adapted to facilitate the condensation of liquid products.

The condenser element (5) preferably has a liquid outlet (52) located at the bottom and a gas outlet (51) located towards the top of the condenser element (5). The liquid products extracted from the condenser element (5) through the liquid outlet (52) are then preferably directed towards a degassing element (6) or a storage tank (b) and the gas products extracted from the condenser element (5) through the gas outlet (51) are preferably directed towards a gas burner element (9) or towards a gas addition port (35) of the reactor element (3), so that such products can be further reacted.

In a particular embodiment, the apparatus of the invention further comprises one or more degassing element(s) (6) comprising a liquid inlet in fluid connection to the liquid outlet (52) of the condenser element (5). The liquid inlet of the degassing element (6) is adapted to enable extraction of the dissolved gases from the liquids originating from the condenser element (5). The degassing element (6) is adapted to depressurize and cool the liquid products originating from the condenser element (5). In a preferred aspect, the degassing element (6) is adapted to degas hydrocarbons with less than five carbon atoms (in the gas state) from larger hydrocarbon products (which remain in the liquid state). The degassing element (6) is preferably provided with one or more liquid outlet(s) (62) located towards the bottom of the degassing element (6) and/or with one or more gas outlet (61) located towards the top of the degassing element (6). Preferably, the degassing element (6) comprises one or more structured element(s) adapted to prevent the liquid product from escaping the degassing element (6) via the gas outlet (61). The liquid products extracted from the degassing element (6) via the liquid outlet (62) are pumped towards a storage tank (b) or to a liquid/liquid separation element (7). The gas products extracted from the degassing element (6) via the liquid outlet (61) are preferably directed towards a compressing unit (10).

In a particular embodiment the apparatus of the present invention comprises a liquid/liquid separating element (7) in fluid connection to the liquid outlet (62) of the degassing element (6) or to the liquid outlet (52) of the condenser element (5), preferably in fluid connection to the liquid outlet (62) of the degassing element (6). The liquid/liquid separating element (7) is adapted to separate the lighter liquid hydrocarbon products from the heavier hydrocarbon products and the aqueous phase. The liquid/liquid separating element (7) preferably comprises a lighter hydrocarbon outlet (71) located at the top of the liquid/liquid separation element (7) and a heavier hydrocarbon outlet (72) located at the bottom of the liquid/liquid separation element (7).

The apparatus of the present invention preferably further comprises a compressing unit (10) in fluid connection to the gas outlet (61) of the degassing element (6). The compressing unit (10) is preferably adapted to compress the hydrocarbons with more than one carbon atom but less than six carbon atoms thus causing their liquefaction. The compressing unit (10) is preferably provided with a cooling system to cool down the fluid to an adequate storage temperature. The compressing unit can further comprise a pump to push the liquified hydrocarbons to a storage tank (b).

### EXAMPLES

### Example 1

### Description of the Apparatus

A melting element (1) was provided consisting of a twin-screw extruder equipped with an inlet in the form of a gravimetric dosing feeding unit, with extraction ports (12) consisting of two top vacuum degassing ports, with an addition port (11) consisting of one liquid injection port located after the degassing port, and with an outlet connected to transfer element (2) having a first switching valve (21) consisting of heated diverter throttle valve. The first switching valve (21) was provided with two outlets, one outlet connected to a heat traced 1-inch stainless steel pipe connected to a reactor (3) consisting of a pressurized hydrocracking reactor and a second outlet connected to a tank (8) consisting of a metal bucket loaded with water.

The outlet of the melting element (1) was equipped with a pressure sensor to monitor the melt pressure. The outlet of the melting element (1) was also equipped with a thermocouple to monitor the melt temperature. The reactor (3) was equipped with a pressure sensor to monitor the pressure inside the reactor.

In addition, the reactor (3) was equipped with a liquid level sensor by means of a multipoint thermocouple. Other means of measuring the level such as radio waves or sonar detection can also be used. However, a differential pressure detector cannot be used as a liquid level sensor, because the density of the mixture is not known at any point in time, hence the reading would not match the volume of the reactor.

In addition, a level switch was installed at the top of the reactor (3) to stop the incoming flow of plastic once the reaction medium touches the switch.

### Safety Mechanism

The first switching valve (21) was set to direct the polymer towards the tank (8) as soon as a differential pressure lower than 5 bar between the pressure sensor at the outlet of the melting element (1) and the pressure sensor inside the reactor (3) was detected. In addition, a level sensor was set to switch the first switching valve (21) towards the tank (8) to prevent overfilling the reactor upon reaching a particular level.

### Operation Procedure

To build pressure in the melt before injecting the plastic into the reactor (3), the first switching valve (21) was set to direct the melt into the tank (8). To control the melt pressure, the first switching valve (21) was adjusted manually to set the pressure above the reactor pressure (Δp~10-20 bar). As soon as the melt pressure was 10-20 bar above the reactor pressure, the first switching valve (21) was switched to feed the plastic into the reactor (3). The continuous feeding was maintained until the reaction was stopped, or one of the safety mechanisms was triggered; either by a decrease in melt pressure at the outlet of the melting element (1), or by the multipoint thermocouple indicating that the maximum level was reached, or by the level sensor switch being in contact with the reactive medium.

In order to melt the plastic, the extruder barrel temperatures in the melting element (1) were set in the range 200-240 °C. To convey the plastics, the set rotating speed of the screws was adjusted based on the dosing rate of the plastic from the gravimetric dosing unit. For instance, the rotating speed was set to 600 rpm.

The vacuum port pressure was set to 600 mbar.

### Trial 1

Constant feeding into the reactor (3) pressurized with hydrogen was successfully demonstrated using two different types of plastic wastes:
a) mixed polyolefin,
   i. where the plastic waste was used, residue-emptied, system-compatible items made of plastic (PE, PP, PS, PET), incl. secondary components such as closures, labels, etc.,
   ii. where the purity according to description is higher or equal to 90.0 wt %,
   iii. where the maximum total of impurities is less or equal to 5.0 wt % where the impurities are describes as Glass, PCC composites (e.g. liquid, cartons), foreign materials (e.g. rubber, stones, wood, textiles, diapers), compostable waste (e.g. food, garden waste),
   iv. where the other metal items are less than 2%, where paper, cardboard and carton are less or equal to 5.0 wt,
   v. where the PET content is less or equal to 4.0 wt %, where the PVC is less or equal than 0.5 wt %,
   vi. where other impurities are less or equal than 3.0 wt %, and
   vii. where the following substances are excluded metallic or mineral impurities with a unit weight is higher than 100 g.
b) plastic foils,
   i. where used, residue-emptied, system compatible items made of plastic foil, area>DIN A4 such as bags, carrier bags and shrink films, incl. secondary components such as closures, labels, etc,
   ii. where the purity is higher or equal to 92.0 wt %,
   iii. where the maximum total of impurities is less or equal to 8.0 wt % where the impurities are describes as Glass, PCC composites (e.g. liquid, cartons), foreign materials (e.g. rubber, stones, wood, textiles, diapers), compostable waste (e.g. food, garden waste). paper, cardboard and carton are less or equal to 1.0 wt %,
   iv. where other impurities are less or equal than 4.0 wt %, here other plastic items are less or equal to 4.0 wt %,
   v. where the colorless transparent foils greater than DIN A3 are higher or equal to 42.0 wt %, and
   vi. where the following substances are excluded metallic or mineral impurities with a unit weight is higher than 100 g .

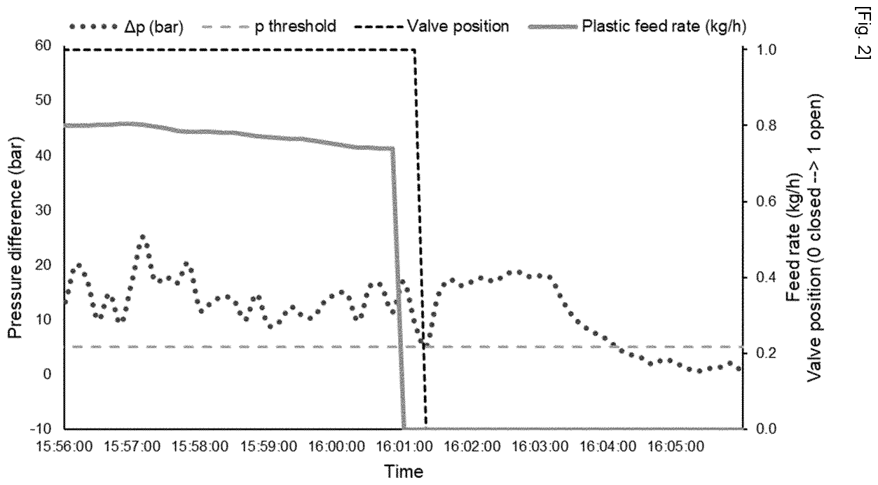

To trigger the mechanism after having continuously operated the reactor in stable conditions for a few hours, the gravimetric dosing unit of the extruder was stopped. The unit continued to run in normal conditions, apart from no new polymer being added to the reactor. The absence of material in the extruder led to a pressure decrease at the outlet, triggering the safety mechanism as soon as the differential pressure reached 5 bar or less, as highlighted in [FIG. 2]. No reverse flow from the reactor (3) was noticed. No flammable gases were detected by the detectors installed inside the unit.

1. An apparatus for continuously hydrocracking plastic comprising:
a) a melting element (1) adapted to melt plastic feedstock, wherein at least part of the plastic feedstock is in solid form, said melting element (1) comprising at least one inlet adapted to introduce the plastic feedstock into the melting element (1), at least one outlet adapted to extract the molten plastic feedstock from the melting element (1), at least one means for conveying the plastic feedstock from the inlet of the melting element (1) to the outlet of the melting element (1) and a pressure sensor provided at the outlet of the melting element (1);
b) a hydrocracking reactor (3) comprising an inlet adapted to continuously introduce molten plastic feedstock into a reactor chamber, at least one outlet adapted to extract hydrocracking products from the reactor (3), at least one hydrogen injection means (31) and a pressure sensor adapted to control the pressure inside the reactor; and
c) a transfer element (2) in fluid connection with the outlet of the melting element (1) and in fluid connection with the inlet of reactor (3);
said plastic hydrocracking apparatus being characterized in that
I. the pressure at the outlet of the melting element (1) is higher than the pressure at the inlet of the melting element (1);
II. the pressure in the reaction chamber of reactor (3) is lower than the pressure at the outlet of the melting element (1);
III. the transfer element (2) comprises at least one first switching valve (22) adapted to either convey the molten plastic feedstock to the inlet of reactor (3) or to a tank (8); and
IV. the reactor (3) is provided with a pressure sensor adapted for sensing the pressure inside the reaction chamber of reactor (3) and for automatically controlling:
1. the at least one first switching valve (22) such as to convey the flow of molten plastic feedstock towards the tank (8) when the pressure in the reaction chamber of reactor (3) exceeds a predetermined level; and/or
2. the at least one means for conveying the plastic feedstock from an inlet of the melting element (1) to an outlet of the melting element (1) to reduce or stop the conveying of plastic feedstock from the inlet of the melting element (1) to the outlet of the melting element (1); or
the at least one means for conveying the plastic feedstock from an inlet of the melting element (1) to an outlet of the melting element (1), to increase the speed of the conveying of the molten plastic feedstock to the outlet of the melting element (1) when the pressure in the reaction chamber of the reactor (3) drops below a predetermined level.

2. The apparatus according to claim 1, wherein the melting element (1) comprises at least one screw to continuously convey the plastic feedstock from the melting element (1) inlet to the melting element (1) outlet while supplying heat by mechanical sheer.

3. (canceled)

4. The apparatus according to claim 2, wherein the melting element (1) is provided with at least one external heating and/or cooling means.

5. (canceled)

6. The plastic hydrocracking apparatus according to claim 1, wherein the melting element (1) is provided with one or more addition port(s) (11) for adding liquids, gases and/or solids and one or more extraction port(s) (12) for applying vacuum.

7-10. (canceled)

11. The plastic hydrocracking apparatus according to claim 1, wherein the pressure sensor provided in the reactor element (3) is adapted to control the at least one first switching valve (22) to convey the plastic feedstock to the collection tank (8) when the pressure in the reaction chamber of the reactor (3) exceeds a predetermined level.

12. The plastic hydrocracking apparatus according to claim 1, wherein the pressure sensor provided in reactor (3) is adapted to control the melting element (1) to stop or to reduce the speed of the conveying of the molten plastic feedstock to the outlet of the melting element (1) when the pressure in the reaction chamber of the reactor (3) exceeds a predetermined level.

13. The plastic hydrocracking apparatus according to any one of claim 1, wherein the reactor (3) comprises a level sensor adapted to detect the level of the reaction mixture in the reaction chamber and further adapted to control
a) The first switching valve (22) to convey the plastic feedstock to the collection tank (8) when level of the reaction mixture in the reaction chamber of reactor (3) exceeds a predetermined level; and/or
b) the at least one means for conveying the plastic feedstock from an inlet of the melting element (1) to an outlet of the melting element (1)to stop or to reduce the speed of the conveying of the molten plastic feedstock to the outlet of the melting element (1) when level of the reaction mixture in the reaction chamber of reactor (3) exceeds a predetermined level; or
the at least one means for conveying the plastic feedstock from an inlet of the melting element (1) to an outlet of the melting element (1) to increase the speed of the conveying of the molten plastic feedstock to the outlet of the melting element (1) when level of the reaction mixture in the reaction chamber of reactor (3) drops below a predetermined level.

14. Use of a plastic hydrocracking apparatus according to claim 1 for the production of hydrocarbon products by hydrocracking from plastic feedstock.

15. A continuous process for the hydrocracking of plastic feedstock, wherein at least part of the plastic feedstock is in the solid state, said process comprising:
a) continuously introducing the plastic feedstock through at least one inlet of a melting element (1) adapted to melt the plastic feedstock;
b) melting the plastic feedstock in the melting element (1);
c) continuously extracting the molten plastic feedstock from the melting element (1) through at least one outlet of the melting element (1);
d) continuously conveying the molten plastic feedstock into the hydrocracking chamber of a reactor (3) through a transfer element (2) and an inlet of the reactor (3);
e) injecting hydrogen into the reaction chamber of reactor 3 to perform the performing a plastic hydrocracking (3) reaction; and
f) extracting the obtained hydrocracking product(s) from the reaction chamber of reactor (3) through at least one outlet element (4) of the reactor (3),
such process being characterized in that
I. the transfer element (2) is in fluid connection with the outlet of the melting element (1) and in fluid connection with the inlet of reactor (3) and comprises at least one first switching valve (22) adapted to either convey the molten plastic feedstock to the inlet of reactor (3) or to a tank (8);
II. the pressure at the outlet of the melting element (1) is higher than the pressure at the inlet of the melting element (1);
III. the pressure in the reaction chamber of reactor (3) is lower than the pressure at the outlet of the melting element (1); and
IV. the reactor (3) is provided with a pressure sensor adapted for sensing the pressure inside the reaction chamber of reactor (3) and for automatically controlling
i. the at least one first switching valve (22) such as to convey part or all of the flow of molten plastic feedstock towards the tank (8) when the pressure in the reaction chamber of reactor (3) exceeds a predetermined level; and/or
ii. the at least one means for conveying the plastic feedstock from an inlet of the melting element (1) to an outlet of the melting element (1) to stop or to reduce the speed of the conveying of the molten plastic feedstock to the outlet of the melting element (1) when the pressure in the reaction chamber of the reactor (3) exceeds a predetermined level; or
the at least one means for conveying the plastic feedstock from an inlet of the melting element (1) to an outlet of the melting element (1), to increase the speed of the conveying of the molten plastic feedstock to the outlet of the melting element (1) when the pressure in the reaction chamber of the reactor (3) exceeds a predetermined level.

16. The process according to claim 15, wherein the plastic feedstock comprises mixed plastic.

17. The plastic hydrocracking apparatus according to claim 1, wherein the reactor element (3) comprises several product outlets.

18. The plastic hydrocracking apparatus according to claim 1, wherein the pressure sensor provided at the outlet of the melting element (1) is adapted to control the pressure at the outlet of the melting element (1) by controlling switching valve (22), to increase the pressure at the outlet of the melting element (1) when it drops below a predetermined level or to reduce the pressure at the outlet of the melting element (1) when it exceeds a predetermined level.

19. The plastic hydrocracking apparatus according to claim 1, wherein the reactor element (3) comprises at least one mixing means, preferably a stirring equipment, a static mixer, a catalyst bed or a passive mixing means.

20. The apparatus according to claim 1, wherein the outlet element (4) is adapted to extract a gas product, a liquid product and/or a slurry product.

21. The apparatus according to claim 1, wherein the reactor element (3) comprises one or more solids addition port(s) (33).

22. The apparatus according to claim 1, wherein the gas injection element (35) and the outlet element (4) are separate elements.

23. The apparatus according to claim 1, wherein the gas injection element (35) and the outlet element (4) are operable simultaneously.

24. The process according to claim 15, wherein the reactor element (3) comprises several product outlets.
